(19) United States
(12) Patent Application Publication
(10) Pub. No.: US 2003/0151281 A1
(43) Pub. Date: Aug. 14, 2003

(54) Remote motor controlled adjustable infant car seat device

(76) Inventor: Regina Williams, (US)

Correspondence Address: Carnes, Cona & Dixon, Innovation Park, 1673 West Paul Dirac Drive, Tallahassee, FL, 32310-3763, US

(21) Appl. No.: 10/068,756

(22) Filed: Feb. 8, 2002

(51) Int. Cl. B60N 2/28

(52) U.S. Cl. 297/250.1; 297/256.16; 297/256.1; 297/254

(57) ABSTRACT

An infant child restraint device is disclosed that is designed and configured to comfortably and safely restrain an infant while providing an device that will enable the changing of position of the seat from an upright to a recline or from a recline position to an upright position. This alteration of positions is accomplished via a movement adjustment apparatus. The present invention further comprises a frame member that will receive the seat shell. The seat frame remains stationary while the seat shell moves about the frame. Secured to the seat shell and the seat frame is the movement adjustment apparatus. This movement adjustment apparatus will push or pull the seat to innately provide for the shell to be in an upright or reclined position.

### BACKGROUND OF THE INVENTION

1. Field of the Invention

The present invention relates generally to a remote motor controlled adjustable infant car seat device and more particularly to a remote motor controlled adjustable infant car seat device that is designed and configured to safely and smoothly change an infant's car seat position from upright to recline without requiring the driver to manually recline the car seat while attempting to drive or having to pull off the roadway for such an adjustment.

2. Background of the Invention

Reclining and adjustable car seats are well known in the file and have been most recently used for adjusting the position of sleeping infants.

For example, U.S. Pat. No. 5,947,556 issued to Strojny discloses a child seat for a vehicle having a shell part, a base for fastening to the vehicle seat and a device for adjusting the seats' inclination. This patent provides for a connection element, which allows for a secured inclination adjustment without requiring the release of the shell from the base during the inclination adjustment, so as prevent the need to interrupt the drive. Although this device may allow for the infant's position to be adjusted while the shell has maintained connection with the base, it fails to address the safety issues for the driver who may be attempting to manipulate the infant seat while still driving. If the driver and the infant were the only passengers in the vehicle, safety reason would necessitate interruption of the drive.

Yet another example can be seen in U.S. Pat. No. 5,890,762 issued to Yoshida wherein disclosed in a child seat that when fixed to a vehicle seat may be adjusted to reclining angle by means of a lock release lever which allows for both the releasing of the locking of reclining, and the releasing of the blocking of the blocking means. This patent provides for the child seat to be reclined by the releasing the lock-release lever and then a winder is provided for securing the seat to the vehicle seat.

Though all these patens address the needs of safety and easily adjustable car seats, many without requiring interruptions of the drive, none of the patents address the need of a remote controlled motorized adjustable infant car seat that is designed and configured to safely and smoothly adjust the infant's position from an upright to a reclined position. As can be seen there exists a need for a device that enables the driver of the vehicle to quickly and efficiently, yet smoothly change the infant's position without taking the focus off of the driving task.

As will be seen, prior techniques do not suggest the present inventive combination of component elements as disclosed and claimed herein by providing a car seat device, which enables adjustment via a remote control apparatus. In addition the present invention is safe and comfortable for maintaining an infant, as well as is a device that is user friendly to inherently render a unit that can be used advantageously be used for a driver that has an infant for a passenger. The present invention achieves its intended purposes, objectives and advantages over the prior art device through a new, useful and unobvious combination of component elements, which is simple to use, with the utilization of a minimum number of functioning components, can be manufactured at a reasonable cost and can be manufactured by employing only readily available material.

### SUMMARY OF THE INVENTION

The present invention is an infant child restraint device designed and configured to comfortably and safely restrain an infant while providing a means of changing the position of the seat from an upright to a recline or from a recline position to an upright position. This alteration of positions is accomplished via a movement adjustment apparatus that is controlled via a remote control device. Utilizing a remote control device provides a unit that does not interfere with the driver's performance, thus, preventing any interrupting in the driving process while enhancing comfort for the infant and safety for the driver.

In order to provide for such a configuration, the present invention comprises a frame member that will receive the seat shell. This seat shell prevents contact between the mechanical movement components and the user of the seat. Secured to the seat shell is the seat cover, which may include padding for providing a comfortable seat. It is noted that this seat cover can be designed so as to be removable. This removable design will enable the item to be removed for washing or the like.

The seat frame includes side panels. Located within the side panels at the upper area is a pair of alignable channels. A second set of channels extends through the side panels located on the lower area or seat area of the seat frame. Extending through the first set of channels is an upper pivot rod. Extending through the lower channels is a second pivot rod. Coupled to this lower pivot rod is the movement adjustment apparatus, which comprises a motor having a screw shaft, attached thereto. A conventional receiver is located within this movement adjustment apparatus or can be located within the seat frame and coupled to the movement adjustment apparatus. Additional support braces extend horizontally on the seat frame. Various channels can be added for permitting seat belts or the like to extend therethrough.

Located on the outer ends of the seat shell are a pair of channels that form a side rests and offer added protection and comfort for the child. These channels are rearwardly located and are optional comfort features. Extending rearwardly from and vertically along the seat shell is a pair of pivot reinforcement members. Each member includes an enlarged upper and lower end having an aperture extending therethrough. This aperture will receive the upper pivot rod and lower pivot rod, respectively, for inherently providing for the seat shell to be secured to the seat frame.

Upon activation of the movement adjustment apparatus, the motor will initiate. This will cause the screw motor to rotate forcing the lower pivot rod to move in a rearward (upright position) or frontward (declined position) motion. The upper pivot rod guides the seat upward or downward to innately provide for a smooth transition between position.

For added safety a lower rigid anchor can be provided for adding more weight and stability to the child restraint device. In addition, a tether device can be added and secured to the shell or frame for providing additional anchoring means for the child restraint device of the present invention. Sensors can also be providing so as to prevent movement, even when the device is activated, of the shell seat when an obstruction is in existence.

Accordingly, it is the object of the present invention to provide for a child restraint device that will overcome the deficiencies, shortcomings, and drawbacks of prior child restraint devices having reclining characteristics and methods of declining thereof.

Still another object of the present invention is to provide a child restraint device that will recline and/or erect in a smooth transitional motion and with the use of a remote control device or the like.

Another object of the present invention, to be specifically enumerated herein, is to provide a tape child restraint device in accordance with the preceding objects and which will conform to conventional forms of manufacture, be of simple construction and easy to use so as to provide a device that would be economically feasible, long lasting and relatively trouble free in operation.

Although there have been many inventions related to child restraint devices, none of the inventions provide for a smooth means of reclining or ejecting a car seat from a remote location, thus increasing the safety for the driver and the child. Additionally, many of these prior inventions fail to be low cost and reliable enough to become commonly used. The present invention meets the requirements of the simplified design, compact size, low initial cost, low operating cost, ease of installation and maintainability, and minimal amount of training to successfully employ the invention.

The foregoing has outlined some of the more pertinent objects of the invention. These objects should be construed to be merely illustrative of some of the more prominent features of the application of the intended invention. Many other beneficial results can be obtained by applying the disclosed invention in a different manner or modifying the invention within the scope of the disclosure. Accordingly, a fuller understanding of the invention may be had by referring to the detailed description of the preferred embodiments in addition to the scope of the invention defined by the claims taken in conjunction with the accompanying drawings.

### BRIEF DESCRIPTION OF THE DRAWINGS

FIG. 1a is a top front perspective view of the child restraint device of the present invention, which is shown in an upright position.

FIG. 1b is a front sideward perspective view of the child restraint device of the present invention, which is shown in a reclined position.

FIG. 2 is a perspective rear view of the child restraint device of the present invention in an upright position.

FIG. 3 is a front perspective view of the seat frame used in the child restraint device of the present invention shown in a recline position.

FIG. 4 is a front perspective view of the seat frame used in the child restraint device of the present invention shown in an upright position.

FIG. 5 is a perspective rear view of the seat shell used in the child restraint device of the present invention shown in a recline position.

Similar reference numerals refer to similar parts throughout the several views of the drawings.

### DETAILED DESCRIPTION OF THE PREFERRED EMBODIMENT

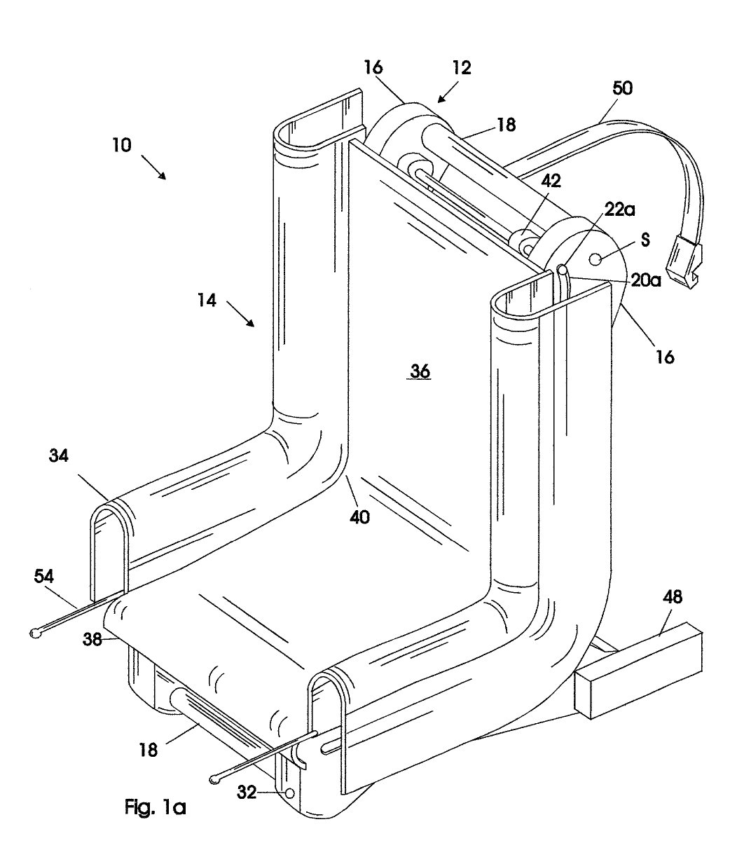

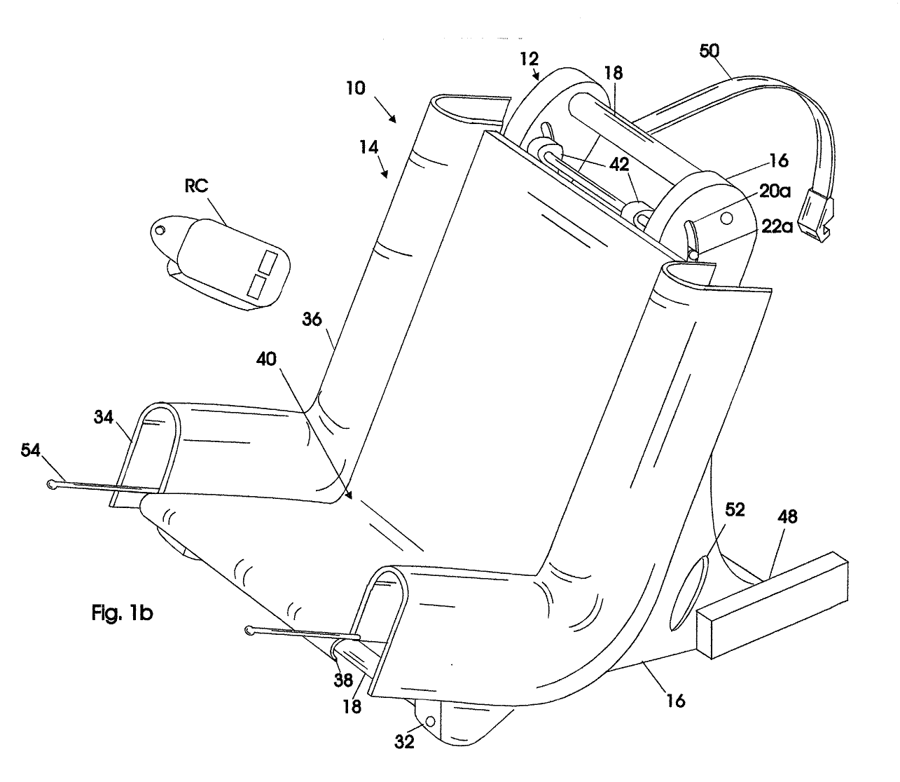

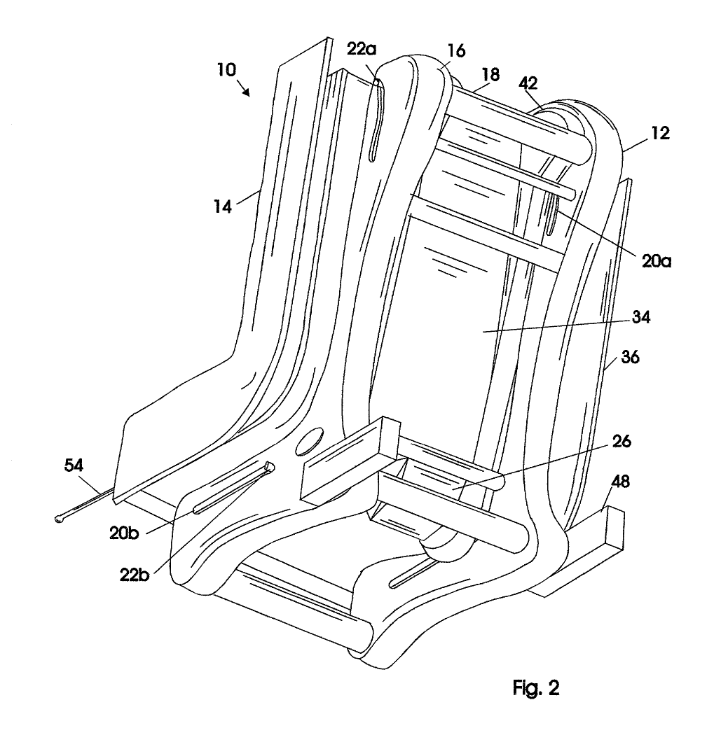

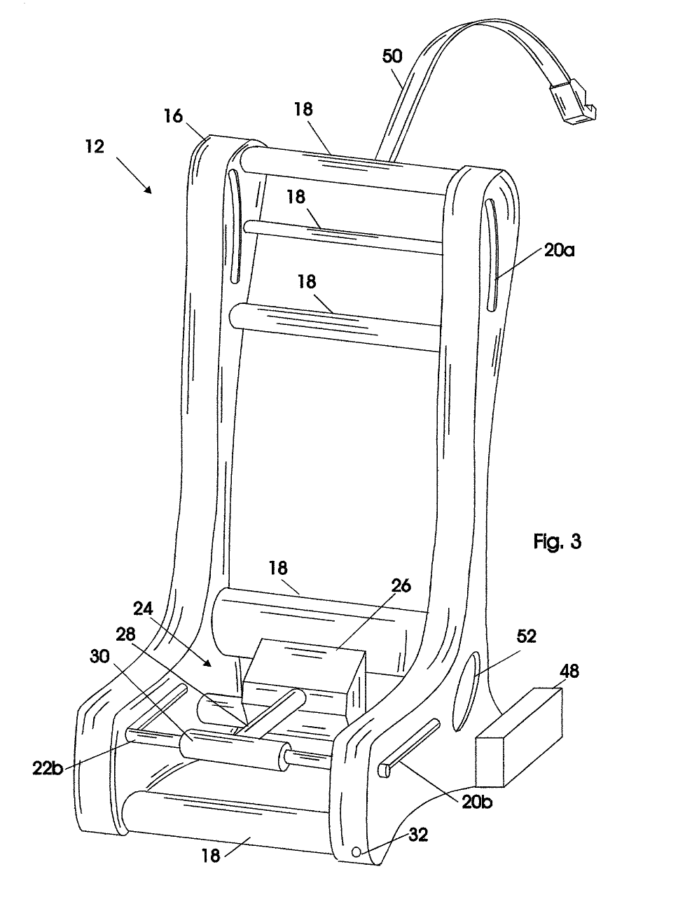

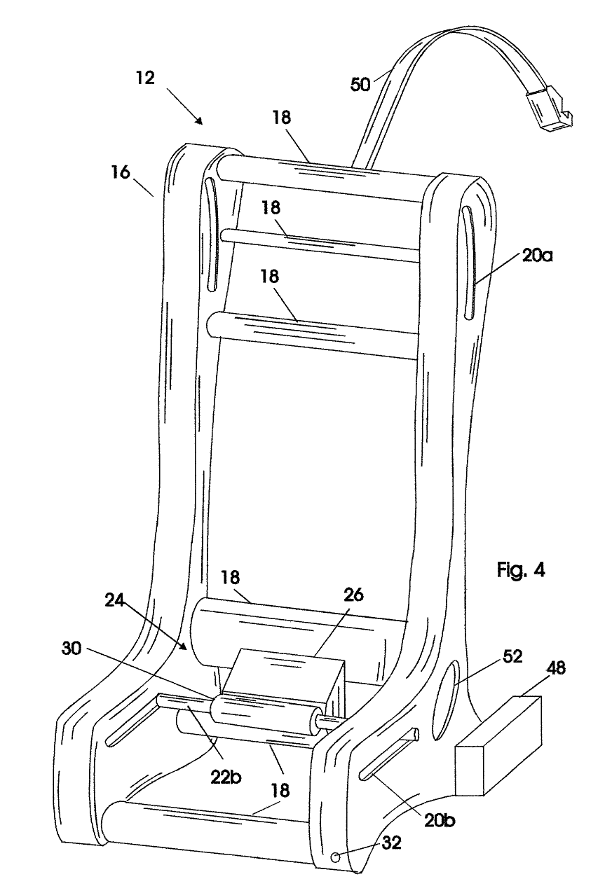

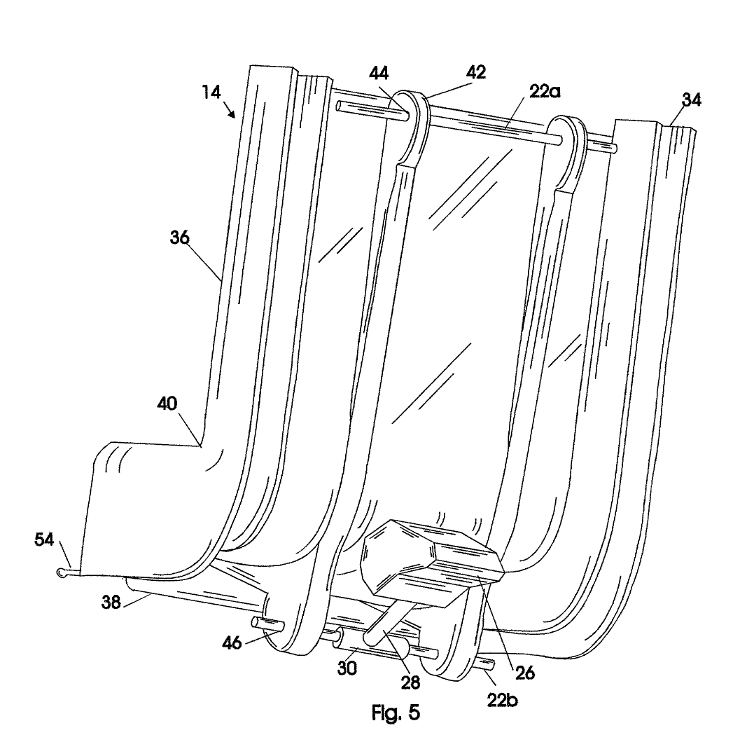

With reference to the drawings, in particular to FIGS. 1a-5 thereof, the present invention, a child restraint device, denoted by reference numeral 10 will be described. Shown is a child restraint device 10 designed and configured to safely maintain a child within a motor vehicle. This child restraint device 10 can be secured to the vehicle in either a frontward or rearward mounting system, dependent upon the child's age and weight and as required by the Federal Motor Vehicle Safety Standards. The purpose of the present invention is to provide for a child restraint device designed and configured to recline or be placed in an upright position when desired. This motion of movement can be accomplished via a remote device, a switch located on the seat, or other conventional activation means. The ability to adjust the seat's position will innately provide a seat that can provide the user with the ultimate level of comfort. In addition, by providing a seat who's movement can be control via a remote will provide for the driver or other passenger to alter the position of the seat without having to move, stop or seize operation of the motor vehicle for successful results.

In order to accomplish such a device, the present invention 10 comprises a seat frame 12 having a seat shell 14 slideably secured thereto. When secured, the seat shell 14 will prevent contact between the mechanical movement components and the user of the seat. Optionally, a seat cover (not illustrated), which may include padding for providing a comfortable seat, may be secured to the seat shell 14. For added versatility, this seat cover, if used, can be constructed so as to be removably secured thereto. This removable design will enable the cover to be removed for washing or the like, thus enhancing the final product.

As seen throughout the figures, the seat frame 12 will include the support needed for the seat shell 14, which is designed to maintain a child. The seat frame 12 will also maintain the mechanical movement device. In use, the seat frame will remain in a secure and fixed position while the mechanical movement device will push or pull the seat shell so as to provide for the shell to be in ether a reclined or upright position.

This seat frame 12 includes a pair of side braces 16. As shown the side braces are substantially L-shaped shaped. This L-shape forms a seat configuration, thereby providing for a vertical area (upper section) and a horizontal area (lower section). Extending horizontally across the braces, and providing structural support is a plurality of horizontal supports 18. These supports enable the seat frame to be in an upright position and will also be used to maintain the mechanical movement device.

Located within the side braces at the upper area is a pair of alignable channels 20a. These upper channels 20a are slightly curved. A second set of channels 20b extends through the side brace located on the lower area or seat area of the seat frame. This second set of channels is horizontally located on the seat. It is noted that the upper area of the side braces is sized so as to adequately accommodate the curved first set of channels, and thus are slightly enlarged for accommodating these channels. The lower area or horizontal area is sized so as to accommodate the channels and the mechanical movement device.

Slideably located within the first set of channels is an upper rod 22a. This rod 22a extends horizontally between the two channels and is secured to the seat shell 14. Thereby providing for the seat shell to be slideably secured to the seat frame 12 via this rod. Slideably located within the second set of channels 20b is a second rod 22b. This second rod 22b extends horizontally between the two channels and is coupled to seat shell 14 and movement adjustment apparatus. The movement adjustment apparatus is secured to the horizontal supports 18 on the seat frame 12.

The second rod 22b is located within the horizontal channels 20b. In operation, the movement adjustment apparatus pushes or pulls the seat shell 14. This pushing or pulling motion will provide for the second rod 22b to move horizontally with the channel. This will inherently provide for the first rod to move vertically within the first set of channels. This movement will innately provide for the seat to be adjusted so as to allow for the seat to be in either an upright or reclined position. The second set of channels and the rod enable the movement of the seat to be accompanied and the first set of channels and the first rod guide the seat 14 so as to provide for a smooth transition.

The movement adjustment apparatus 24, which is secured to a pair or horizontal supports located at the lower section of the frame 12 comprises a motor 26. This motor includes a screw shaft 28, attached thereto. Perpendicularly secured to the screw shaft is a hollow shank 30 that receives the second rod 22b.

Accordingly, when the motor is activated, the screw shaft will move forward (for reclined position) or pull rearward (for upright position) and will push or pull the second rod 22b along the second set of channels 22b. Inherently causing the first rod down or up along the first set of channels. This movement adjustment apparatus 24 enables the desired positioning while the first set of channels enables the movement to occur smoothly.

Activation can occur by the use of a manual operation switch S located on the shell 12, as seen in FIG. 1a or via a remote control device RC, as shown in FIG 1b. Thereby providing for a child restraint seat 10 having a switch for activation, a remote for activation or a combination thereof. The combination will allow for more versatility for use.

When having a remote control unit, the movement adjustment apparatus will include a conventional receiver or the seat frame can include the receiver 32, as illustrated be coupled to the movement adjustment apparatus. This design will provide for the wiring to occur within the brace and horizontal supports of the seat frame. The remote control device RC will include a conventional transmitter for transiting a signal for activation the movement adjustment apparatus in the desired position.

The shell 14, as seen in FIGS. 1a, 1b, 2 and 5 is preferably fabricated from a durable material and its purpose is to maintain a child and to prevent the mechanical movement devices from contacting the user of the seat. As such, the shell 14 has a seat-like configuration and includes outer arms 34 that are preferably curved, as illustrated. This curved feature will aid in the comfort and structural integrity of the shell as well as prevent any hard surfaces that can inadvertently cause injury or harm to a child. Sandwiched between the arms is the L-shape chair portion 36. The lower end 38 of the chair is curved. The seat further includes a section 40, which defines the point, which the chair extends vertically and horizontally for inherently forming an L-shape configuration. It is noted that the inner portion of the arm is desirably shorter in width than the outer arm. This will provide for the inner arm to be alignable with the chair portion 36 and will consequently provide for the outer arm to extend beyond the rods so as to add to the safety of the present invention and to prevent any contact with the mechanical components.

Providing structural integrity to the chair portion 36 are a pair of supports 42 that are externally located thereto. The supports are parallel from each other and extend from the upper section of the chair portion to the lower end 38 of the chair portion. Extending through the upper end of each support is an aperture 44. This aperture 44 will receive and maintain the first rod 22a. Thereby, providing for the first rod to be secured to the shell. The ends of the rods will be located within the first set of channels 20a of the seat frame 12. The arms are designed such that they will extend beyond the ends of the rod and side braces 16 of the seat frame 12 so as to be unobtrusive. It is noted that to accommodate the apertures and rod, the horizontal braces can be enlarged in the area of the apertures 44.

Extending through each support, in the area of the defining section 40, and rearwardly thereof is a pair of apertures 46. These apertures 46 will receive and maintain the second rod 22b. Thereby, providing for the second rod to be secured to the shell. This lower rod 22b will extend through shank 30 and will also be located within the second set of channels 20b of the seat frame 12. Such a configuration will provide for the movement apparatus 24 to be secured to the seat shell 14. Thus providing for the seat shell to be slideably mounted to the seat frame 12. Though not illustrated, various restraining straps, known as seat belts, will be secured to the seat frame 14 and enable the child to be properly restrain. The straps will be secured in a conventional manner.

Various features have been added for increasing the safety of the child restraint device of the present invention. One feature is the use of a lower rigid anchor 48. This anchor provides an adequate amount of weight for enabling the device to be stable when secured to a seat of a vehicle. Yet another safety feature is the use of a tether 50. This tether offers another means of anchoring the present invention 10 to the seat of a motor vehicle. In addition, the braces 16 of the seat frame 12 can each include an orifice 52 therein for receiving a conventional seat belt of a motor vehicle. This will provide for a conventional means of attaching the present invention to a seat of a motor vehicle.

Various sensors 54 can be strategically placed on the seat frame, as seen in FIG. 1a. The use of the sensors 54 will provide an awareness as to an obstruction. If an obstruction is present, then the movement adjustment apparatus will cease operation. Optionally, an audio and/or visual device can be coupled to the sensors so as to provide for a means of alerting an adult of a potential dangerous situation.

While the present invention has been particularly shown and described with reference to an embodiment thereof, it will be understood by those skilled in the art that various changes in form and detail may be made without departing from the spirit and scope of the present invention.

I claim:

1. A child restraint device comprising:
a seat frame;
a seat shell is slideably mounted to said seat frame;
a movement adjustment apparatus couples said seat shell to said seat frame for providing said seat shell to move about said frame so as to provide for said seat shell to be adjusted as desired by a user, said seat frame remains stationary.

2. A child restraint device as in claim 1 wherein a padded seat cover is secured to said seat shell.

3. A child restraint device as in claim wherein a plurality of sensors are secured to said seat frame for ceasing operation of said movement adjustment apparatus when an obstruction is present.

4. A child restraint device as in claim 1 wherein said movement adjustment apparatus includes a motor having an arm attached thereto, said motor is secured to said seat frame and said arm is secured to said seat shell, upon activation of said motor, said arm moves forward or rearward, pushing or pulling said seat shell to a desired position.

5. A child restraint device as in claim 1 wherein an anchor is secured to said seat frame for securing the seat frame firmly in a desired location.

6. A child restraint device as in claim 1 wherein said movement adjustment apparatus is controlled via a remote control device.

7. A child restraint device as in claim 6 wherein a switch is also used to control said movement adjustment apparatus.
